(19) United States
(12) Patent Application Publication
(10) Pub. No.: US 2022/0350321 A1
(43) Pub. Date: Nov. 3, 2022

(54) Maintenance Monitoring System and Method

(71) Applicant: SALT & LIGHT ENERGY EQUIPMENT, LLC, Dallas, TX (US)

(72) Inventors: Soham Pandya, Edmond, OK (US); Shawn Mudigere, Dallas, TX (US)

(21) Appl. No.: 17/730,770

(22) Filed: Apr. 27, 2022

Related U.S. Application Data
(60) Provisional application No. 63/181,830, filed on Apr. 29, 2021.

(51) Int. Cl. G05B 23/02; E21B 43/26; G06F 3/0481

(52) U.S. Cl. CPC G05B 23/0208; E21B 43/26; G06F 3/0481; G06Q 10/20

(57) ABSTRACT

A computer-implemented method, computer program product and computing system for: monitoring one or more maintenance operations performed on one or more fracking pumps to generate consolidated maintenance information concerning the one or more fracking pumps; and rendering a graphical user interface that is configured to present at least a portion of the consolidated maintenance information to a user, thus defining rendered consolidated maintenance information.

### RELATED APPLICATION(S)

This application claims the benefit of U.S. Provisional Application No. 63/181,830, filed on 29 Apr. 2021, the entire contents of which are incorporated herein by reference.

### TECHNICAL FIELD

This disclosure relates to maintenance monitoring systems and, more particularly, to maintenance monitoring systems for use within fracking systems.

### BACKGROUND

As is known in the art, fracking is a well stimulation technique involving the fracturing of bedrock formations using a pressurized liquid. The fracking process involves the high-pressure injection (@ 10,000-14,000 PSI) of fracking fluid (primarily water, containing sand or other proppants suspended with the aid of thickening agents) into a well bore to create fractures in the deep-rock formations through which natural gas and petroleum will flow more freely. When the hydraulic pressure is removed from the well bore, small grains of hydraulic fracturing proppants hold the fractures open, thus allowing the continued flow of the natural gas and petroleum from the bore.

A fracking pump may include a plurality of plungers that are configured to pressurize fracking fluid that is received from a fracking fluid supply. As would be expected, these fracking pumps are subjected to high workloads during their use. Accordingly, performing routine maintenance is of paramount importance with respect to preventing failures and the resulting downtime.

### SUMMARY OF DISCLOSURE

In one implementation, a computer-implemented method is executed on a computing device and includes: monitoring one or more maintenance operations performed on one or more fracking pumps to generate consolidated maintenance information concerning the one or more fracking pumps; and rendering a graphical user interface that is configured to present at least a portion of the consolidated maintenance information to a user, thus defining rendered consolidated maintenance information.

One or more of the following features may be included. The rendered consolidated maintenance information may include one or more of: consolidated general information; consolidated crew information; consolidated failure information; and consolidated inventory information. Monitoring one or more maintenance operations performed on one or more fracking pumps to generate consolidated maintenance information concerning the one or more fracking pumps may include: receiving maintenance data concerning one or more maintenance operations performed on one or more fracking pumps. Monitoring one or more maintenance operations performed on one or more fracking pumps to generate consolidated maintenance information concerning the one or more fracking pumps may further include: processing the maintenance data to generate the consolidated maintenance information concerning the one or more fracking pumps based, at least in part, upon the maintenance data. The maintenance data may include one or more of: crew data; failure data; inventory data; efficiency data; and identifying data. The consolidated maintenance information may be processed to generate one or more recommendations concerning the one or more fracking pumps. The one or more recommendations may include one or more maintenance recommendations. The one or more recommendations may include one or more inspection recommendations. The one or more recommendations may include one or more replacement recommendations. The graphical user interface may be configured to allow the user to define an observation window.

In another implementation, a computer program product resides on a computer readable medium and has a plurality of instructions stored on it. When executed by a processor, the instructions cause the processor to perform operations including: monitoring one or more maintenance operations performed on one or more fracking pumps to generate consolidated maintenance information concerning the one or more fracking pumps; and rendering a graphical user interface that is configured to present at least a portion of the consolidated maintenance information to a user, thus defining rendered consolidated maintenance information.

One or more of the following features may be included. The rendered consolidated maintenance information may include one or more of: consolidated general information; consolidated crew information; consolidated failure information; and consolidated inventory information. Monitoring one or more maintenance operations performed on one or more fracking pumps to generate consolidated maintenance information concerning the one or more fracking pumps may include: receiving maintenance data concerning one or more maintenance operations performed on one or more fracking pumps. Monitoring one or more maintenance operations performed on one or more fracking pumps to generate consolidated maintenance information concerning the one or more fracking pumps may further include: processing the maintenance data to generate the consolidated maintenance information concerning the one or more fracking pumps based, at least in part, upon the maintenance data. The maintenance data may include one or more of: crew data; failure data; inventory data; efficiency data; and identifying data. The consolidated maintenance information may be processed to generate one or more recommendations concerning the one or more fracking pumps. The one or more recommendations may include one or more maintenance recommendations. The one or more recommendations may include one or more inspection recommendations. The one or more recommendations may include one or more replacement recommendations. The graphical user interface may be configured to allow the user to define an observation window.

In another implementation, a computing system includes a processor and memory is configured to perform operations including: monitoring one or more maintenance operations performed on one or more fracking pumps to generate consolidated maintenance information concerning the one or more fracking pumps; and rendering a graphical user interface that is configured to present at least a portion of the consolidated maintenance information to a user, thus defining rendered consolidated maintenance information.

One or more of the following features may be included. The rendered consolidated maintenance information may include one or more of: consolidated general information; consolidated crew information; consolidated failure information; and consolidated inventory information. Monitoring one or more maintenance operations performed on one or more fracking pumps to generate consolidated maintenance information concerning the one or more fracking pumps may include: receiving maintenance data concerning one or more maintenance operations performed on one or more fracking pumps. Monitoring one or more maintenance operations performed on one or more fracking pumps to generate consolidated maintenance information concerning the one or more fracking pumps may further include: processing the maintenance data to generate the consolidated maintenance information concerning the one or more fracking pumps based, at least in part, upon the maintenance data. The maintenance data may include one or more of: crew data; failure data; inventory data; efficiency data; and identifying data. The consolidated maintenance information may be processed to generate one or more recommendations concerning the one or more fracking pumps. The one or more recommendations may include one or more maintenance recommendations. The one or more recommendations may include one or more inspection recommendations. The one or more recommendations may include one or more replacement recommendations. The graphical user interface may be configured to allow the user to define an observation window.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a illustrative view of a fracking operation;

FIG. 2 is a diagrammatic view of a fracking pump according to an embodiment of the present disclosure;

FIG. 3 is a cross-sectional view of a portion of the fracking pump of FIG. 2 according to an embodiment of the present disclosure;

FIG. 4 is a diagrammatic view of a distributed computing network including a computing device that executes a maintenance monitoring process according to an embodiment of the present disclosure;

FIG. 5 is a diagrammatic view of a plurality of fracking pumps according to an embodiment of the present disclosure;

FIG. 6 is a flowchart of an implementation of the maintenance monitoring process of FIG. 4 according to an embodiment of the present disclosure; and

FIG. 7A-7E are diagrammatic views of graphical user interfaces rendered by the maintenance monitoring process of FIG. 4 according to an embodiment of the present disclosure.

Like reference symbols in the various drawings indicate like elements.

### DETAILED DESCRIPTION OF THE PREFERRED EMBODIMENTS

System Overview

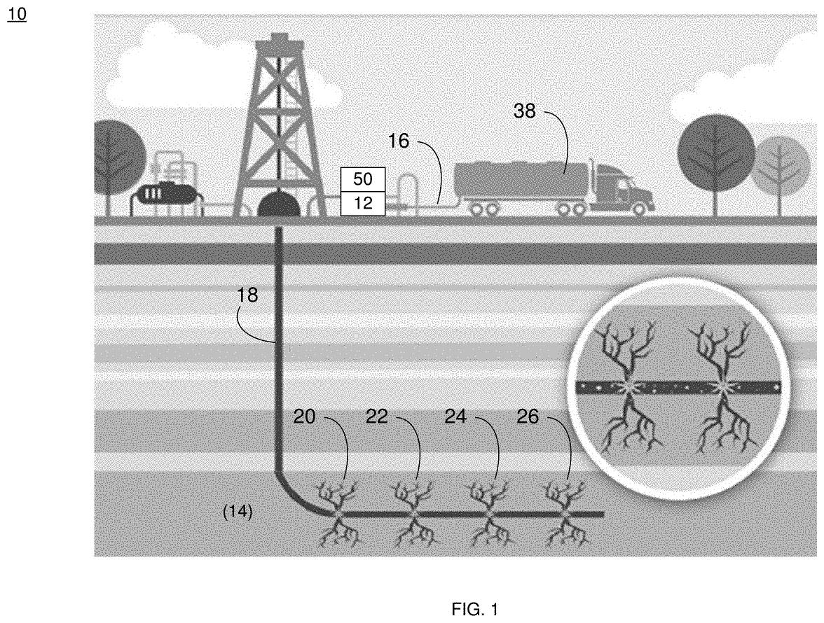

Referring to FIG. 1, there is shown fracking system 10. Fracking system 10 may include fracking pump 12 (sometimes referred to as a fluid end) configured for use with fracking operations. As discussed above, fracking is a well stimulation technique involving the fracturing of bedrock formations (e.g., bedrock formations 14) using a pressurized liquid (e.g., fracking fluid 16). The fracking process involves the high-pressure injection (@ 10,000-14,000 PSI) of fracking fluid 16 (primarily water, containing sand or other proppants suspended with the aid of thickening agents) into a well bore (e.g., well bore 18) to create fractures (e.g., fractures 20, 22, 24, 26) in the deep-rock formations (e.g., bedrock formations 14) through which natural gas and petroleum will flow more freely. When the hydraulic pressure is removed from the well bore (e.g., well bore 18), small grains of hydraulic fracturing proppants (either sand or aluminum oxide) hold the fractures open, thus allowing the continued flow of the natural gas and petroleum from the bore (e.g., well bore 18).

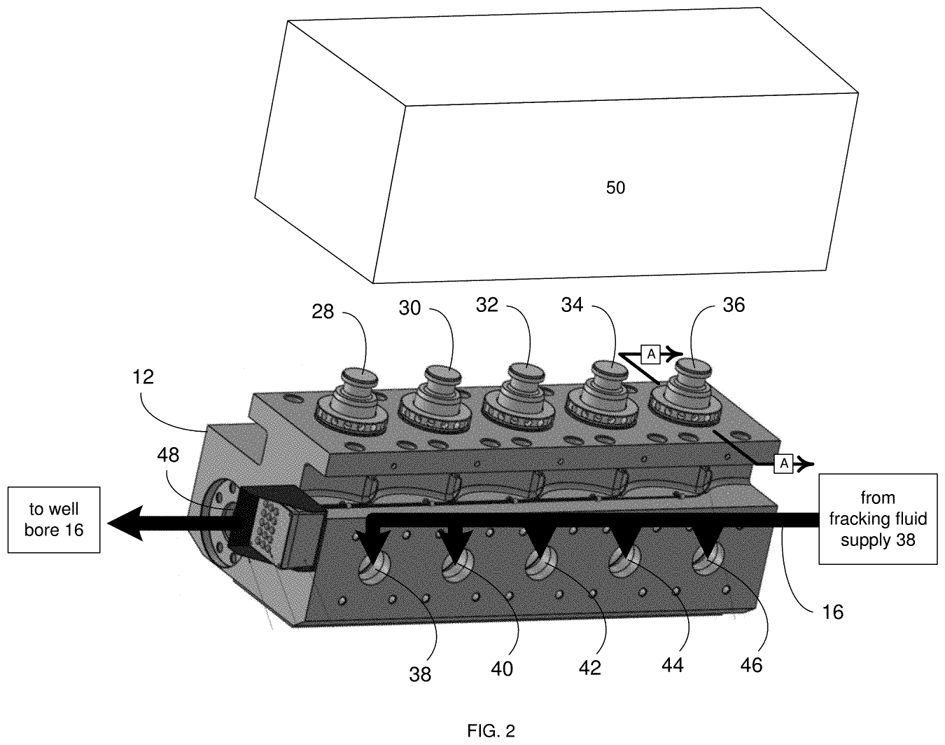

Referring also to FIG. 2, fracking pump 12 may include a plurality of plungers (e.g., plungers 28, 30, 32, 34, 36) that are configured to pressurize fracking fluid (e.g., fracking fluid 16) that is received from a fracking fluid supply (e.g., fracking fluid supply 38). Examples of fracking fluid supply 38 may include but are not limited to a tanker truck capable of transporting fracking fluid 16. Fracking fluid supply 38 may provide fracking fluid 16 to inlet ports 38, 40, 42, 44, 46 associated with plungers 28, 30, 32, 34, 36 (respectively), wherein plungers 28, 30, 32, 34, 36 may pressurize fracking fluid 16, which is made available via outlet port 48 to well bore 18.

Power system 50 (sometimes referred to as a power end) may be configured to provide power to fracking pump 12. Examples of power system 50 may include but are not limited to a diesel engine, a gasoline engine, and an electric motor. During operation, power system 50 may be configured to reciprocate plungers 28, 30, 32, 34, 36, resulting in the drawing of fracking fluid 16 into inlet ports 38, 40, 42, 44, 46 (during the suction portion of the reciprocating motion of plungers 28, 30, 32, 34, 36) and the subsequent expulsions of fracking fluid 16 from outlet port 48 (during the pressure portion of the reciprocating motion of plungers 28, 30, 32, 34, 36), wherein fracking fluid 16 (now pressurized) may be provided to well bore 18 to effectuate the above-described fracking operation.

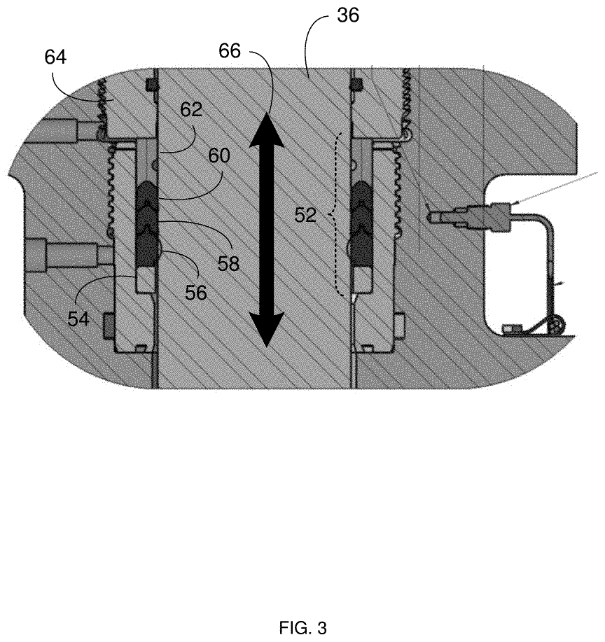

Referring to FIG. 3, there is shown a cross-sectional view of fracking pump 12 (along section line A-A), illustrating plunger 36 and packing assembly 52. In this particular configuration, packing assembly 52 is shown to include ring assembly 54, seal assemblies 56, 58, 60 and bushing assembly 62, all of which are held in place by packing nut 64. Specifically, packing assembly 52 may be a static packing assembly, wherein plunger 36 may reciprocate (upward & downward) in the direction of arrow 66.

Maintenance Monitoring System

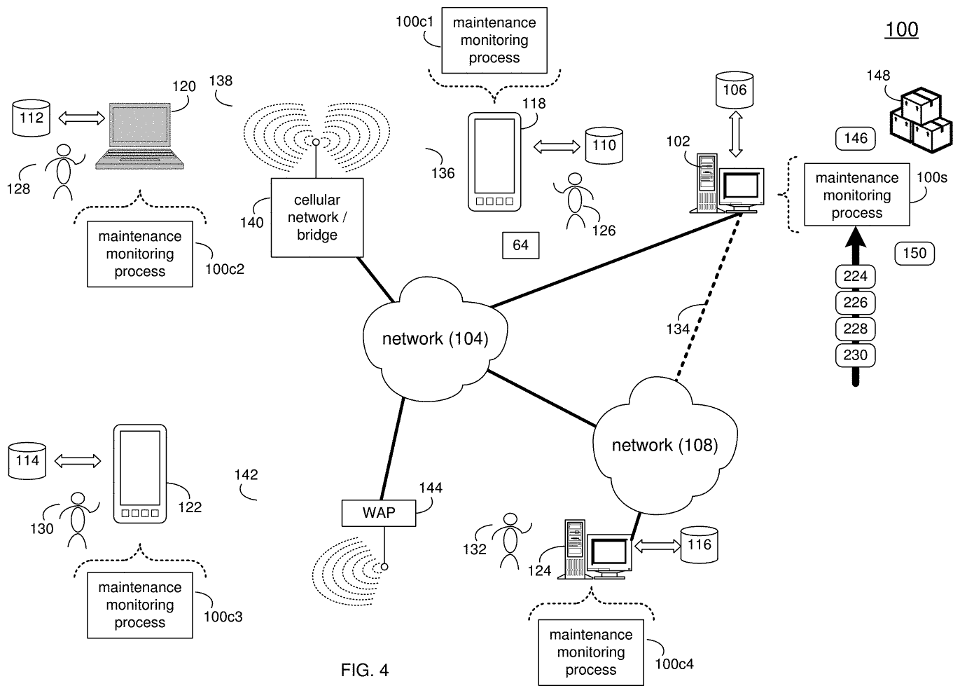

Referring to FIG. 4, there is shown maintenance monitoring process 100. Maintenance monitoring process 100 may be implemented as a server-side process, a client-side process, or a hybrid server-side/client-side process. For example, maintenance monitoring process 100 may be implemented as a purely server-side process via maintenance monitoring process 100s. Alternatively, maintenance monitoring process 100 may be implemented as a purely client-side process via one or more of maintenance monitoring process 100c1, maintenance monitoring process 100c2, maintenance monitoring process 100c3, and maintenance monitoring process 100c4. Alternatively still, maintenance monitoring process 100 may be implemented as a hybrid server-side/client-side process via maintenance monitoring process 100s in combination with one or more of maintenance monitoring process 100c1, maintenance monitoring process 100c2, maintenance monitoring process 100c3, and maintenance monitoring process 100c4. Accordingly, maintenance monitoring process 100 as used in this disclosure may include any combination of maintenance monitoring process 100s, maintenance monitoring process 100c1, maintenance monitoring process 100c2, maintenance monitoring process, and maintenance monitoring process 100c4.

Maintenance monitoring process 100s may be a server application and may reside on and may be executed by computing device 102, which may be connected to network 104 (e.g., the Internet or a local area network). Examples of computing device 102 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of maintenance monitoring process 100s, which may be stored on storage device 106 coupled to computing device 102, may be executed by one or more processors (not shown) and one or more memory architectures (not shown) included within computing device 102. Examples of storage device 106 may include but are not limited to: a hard disk drive; a RAID device; a random-access memory (RAM); a read-only memory (ROM); and all forms of flash memory storage devices.

Network 104 may be connected to one or more secondary networks (e.g., network 108), examples of which may include but are not limited to: a local area network; a wide area network; or an intranet, for example.

Examples of maintenance monitoring processes 100c1, 100c2, 100c3, 100c4 may include but are not limited to a client application, a web browser, a game console user interface, or a specialized application (e.g., an application running on e.g., the Android™ platform or the iOS™ platform). The instruction sets and subroutines of maintenance monitoring processes 100c1, 100c2, 100c3, 100c4, which may be stored on storage devices 110, 112, 114, 116 (respectively) coupled to client electronic devices 118, 120, 122, 124 (respectively), may be executed by one or more processors (not shown) and one or more memory architectures (not shown) incorporated into client electronic devices 118, 120, 122, 124 (respectively). Examples of storage devices 110, 112, 114, 116 may include but are not limited to: a hard disk drive; a RAID device; a random access memory (RAM); a read-only memory (ROM); and all forms of flash memory storage devices.

Examples of client electronic devices 118, 120, 122, 124 may include, but are not limited to, data-enabled, cellular telephone 118, laptop computer 120, personal digital assistant 122, personal computer 124, a notebook computer (not shown), a server computer (not shown), a gaming console (not shown), a smart television (not shown), and a dedicated network device (not shown). Client electronic devices 118, 120, 122, 124 may each execute an operating system, examples of which may include but are not limited to Microsoft Windows™, Android™, WebOS™, iOS™, Redhat Linux™, or a custom operating system.

Users 126, 128, 130, 132 may access maintenance monitoring process 100 directly through network 104 or through secondary network 108. Further, maintenance monitoring process 100 may be connected to network 104 through secondary network 108, as illustrated with link line 134.

The various client electronic devices (e.g., client electronic devices 118, 120, 122, 124) may be directly or indirectly coupled to network 104 (or network 108). For example, data-enabled, cellular telephone 118 and laptop computer 120 are shown wirelessly coupled to network 104 via wireless communication channels 136, 138 (respectively) established between data-enabled, cellular telephone 118, laptop computer 120 (respectively) and cellular network/bridge 140, which is shown directly coupled to network 104. Further, personal digital assistant 122 is shown wirelessly coupled to network 104 via wireless communication channel 142 established between personal digital assistant 122 and wireless access point (i.e., WAP) 144, which is shown directly coupled to network 104. Additionally, personal computer 124 is shown directly coupled to network 108 via a hardwired network connection.

WAP 144 may be, for example, an IEEE 802.11a, 802.11b, 802.11g, 802.11n, Wi-Fi, and/or Bluetooth device that is capable of establishing wireless communication channel 142 between personal digital assistant 122 and WAP 144. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

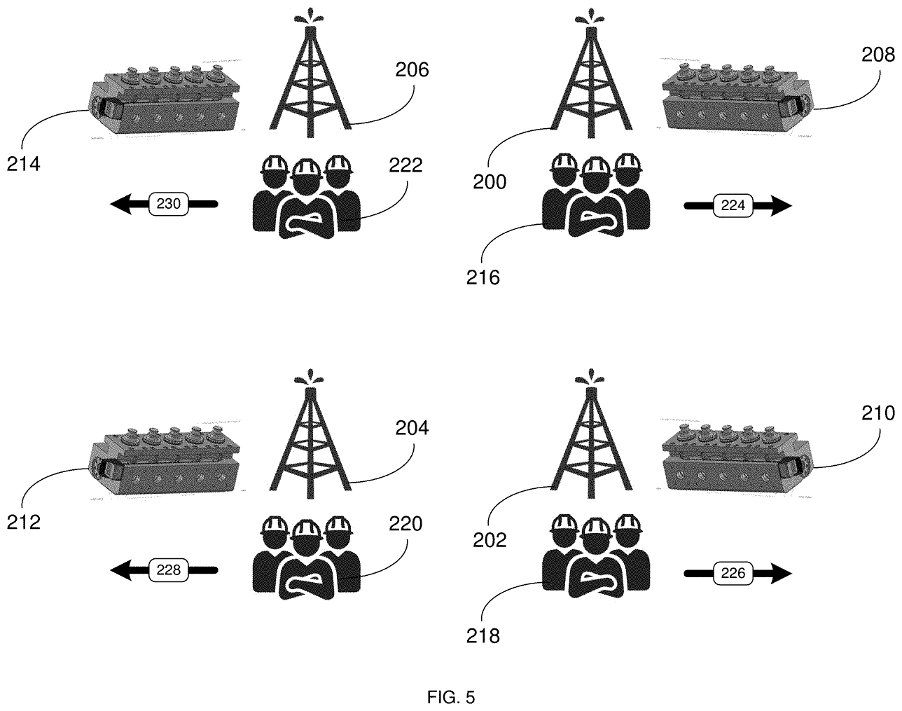

Referring also to FIG. 5, various well bores (e.g., well bores 200, 202, 204, 206) may be serviced by various fracking pumps (e.g., fracking pumps 208, 210, 212, 214), wherein these various fracking pumps (e.g., fracking pumps 208, 210, 212, 214) may be maintained by various maintenance crews (e.g., maintenance crews 216, 218, 220, 222).

In order to extend the operation of the fracking pumps (e.g., fracking pumps 208, 210, 212, 214), routine maintenance may be performed on these fracking pumps (e.g., fracking pumps 208, 210, 212, 214) to reduce the occurrence of downtime and/or failures.
For example, maintenance crew 216 may perform routine maintenance operations/procedures on fracking pump 208, wherein the routine maintenance operations/procedures performed by maintenance crew 216 may be memorialized within maintenance reports (e.g., maintenance data 224) that may be provided to maintenance monitoring process 100 for e.g., consolidation/correlation.
Further, maintenance crew 218 may perform routine maintenance operations/procedures on fracking pump 210, wherein the routine maintenance operations/procedures performed by maintenance crew 218 may be memorialized within maintenance reports (e.g., maintenance data 226) that may be provided to maintenance monitoring process 100 for e.g., consolidation/correlation.
Additionally, maintenance crew 220 may perform routine maintenance operations/procedures on fracking pump 212, wherein the routine maintenance operations/procedures performed by maintenance crew 220 may be memorialized within maintenance reports (e.g., maintenance data 228) that may be provided to maintenance monitoring process 100 for e.g., consolidation/correlation.
Further, maintenance crew 222 may perform routine maintenance operations/procedures on fracking pump 214, wherein the routine maintenance operations/procedures performed by maintenance crew 222 may be memorialized within maintenance reports (e.g., maintenance data 230) that may be provided to maintenance monitoring process 100 for e.g., consolidation/correlation.

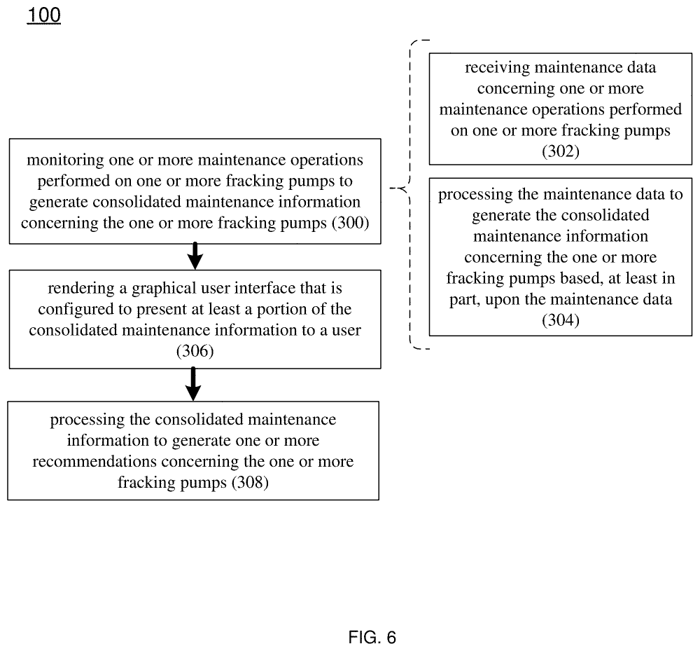

Referring also to FIG. 6, maintenance monitoring process 100 may be utilized to provide a more holistic view of the maintenance operations/procedures performed on (in this example) fracking pumps 208, 210, 212, 214 by maintenance crews 216, 218, 220, 222.

For example, maintenance monitoring process 100 may monitor 300 one or more maintenance operations performed (by e.g., maintenance crews 216, 218, 220, 222) on one or more fracking pumps (e.g., fracking pumps 208, 210, 212, 214) to generate consolidated maintenance information (e.g., consolidated maintenance information 146) concerning the one or more fracking pumps (e.g., fracking pumps 208, 210, 212, 214).

When monitoring 300 one or more maintenance operations performed (by e.g., maintenance crews 216, 218, 220, 222) on one or more fracking pumps (e.g., fracking pumps 208, 210, 212, 214) to generate consolidated maintenance information (e.g., consolidated maintenance information 146) concerning the one or more fracking pumps (e.g., fracking pumps 208, 210, 212, 214), maintenance monitoring process 100 may receive 302 maintenance data (e.g., maintenance data 224, 226, 228, 230) concerning one or more maintenance operations performed (by e.g., maintenance crews 216, 218, 220, 222) on one or more fracking pumps (e.g., fracking pumps 208, 210, 212, 214).

The maintenance data (e.g., maintenance data 224, 226, 228, 230) may include one or more of: crew data; failure data; inventory data; efficiency data; and identifying data.
Crew Data: The maintenance data (e.g., maintenance data 224, 226, 228, 230) may include crew data, wherein such crew data may identify a particular maintenance crew (e.g., one of maintenance crews 216, 218, 220, 222) that performed a particular maintenance operation/procedure on a particular fracking pump (e.g., fracking pumps 208, 210, 212, 214). By monitoring (on a granular level) the performance of such maintenance crews (e.g., maintenance crews 216, 218, 220, 222), comparisons may be made and efficiencies may be gauged.
Failure Data: The maintenance data (e.g., maintenance data 224, 226, 228, 230) may include failure data, wherein such failure data may identify the rate at which the fracking pumps (e.g., fracking pumps 208, 210, 212, 214) may fail, as well as the rate at which various components/subcomponents of these fracking pumps (e.g., fracking pumps 208, 210, 212, 214) may fail. By monitoring (on a granular level) the failure rates of such fracking pumps (e.g., fracking pumps 208, 210, 212, 214) and the components/subcomponents contained therein, comparisons may be made and the longevity/reliability of such fracking pumps (e.g., fracking pumps 208, 210, 212, 214) and the components/subcomponents contained therein may be gauged.
Inventory Data: The maintenance data (e.g., maintenance data 224, 226, 228, 230) may include inventory data, wherein such inventory data may identify the components/subcomponents that were utilized/consumed when a particular maintenance crew (e.g., one of maintenance crews 216, 218, 220, 222) performed a particular maintenance operation/procedure on a particular fracking pump (e.g., fracking pumps 208, 210, 212, 214). By monitoring (on a granular level) the components/subcomponents that were utilized/consumed when performing maintenance operations/procedures on the fracking pumps (e.g., fracking pumps 208, 210, 212, 214), the inventory (e.g., inventory 148) of components utilized to maintain these fracking pumps (e.g., fracking pumps 208, 210, 212, 214) may be maintained to ensure the such components/subcomponents are available when needed.
Efficiency Data: The maintenance data (e.g., maintenance data 224, 226, 228, 230) may include efficiency data, wherein such efficiency data may enable comparisons between different entities. As discussed above, by monitoring (on a granular level) the performance of such maintenance crews (e.g., maintenance crews 216, 218, 220, 222), comparisons may be made and efficiencies may be gauged. Further and as discussed above, by monitoring (on a granular level) the failure rates of such fracking pumps (e.g., fracking pumps 208, 210, 212, 214) and the components/subcomponents contained therein, comparisons may be made and the longevity/reliability of such fracking pumps (e.g., fracking pumps 208, 210, 212, 214) and the components/subcomponents contained therein may be gauged. Accordingly, such efficiency data may enable comparisons between different entities, examples of which may include but are not limited to maintenance crews (e.g., maintenance crews 216, 218, 220, 222), fracking pumps (e.g., fracking pumps 208, 210, 212, 214), and the components/subcomponents contained therein.
Identifying Data: The maintenance data (e.g., maintenance data 224, 226, 228, 230) may include identifying data, wherein such identifying data may identify the specifics of the fracking pumps (e.g., fracking pumps 208, 210, 212, 214) and the components/subcomponents contained therein. For example, such identifying data may identify e.g., the make/model/serial number of the fracking pumps (e.g., fracking pumps 208, 210, 212, 214) and the components/subcomponents contained therein. By monitoring (on a granular level) e.g., the make/model/serial number of the fracking pumps (e.g., fracking pumps 208, 210, 212, 214) and the components/subcomponents contained therein, replacement parts may be easily identified and ordered, thus enhancing the efficiency the maintenance crews (e.g., maintenance crews 216, 218, 220, 222) servicing the fracking pumps (e.g., fracking pumps 208, 210, 212, 214).

When monitoring 300 one or more maintenance operations performed (by e.g., maintenance crews 216, 218, 220, 222) on one or more fracking pumps (e.g., fracking pumps 208, 210, 212, 214) to generate consolidated maintenance information (e.g., consolidated maintenance information 146) concerning the one or more fracking pumps (e.g., fracking pumps 208, 210, 212, 214), maintenance monitoring process 100 may process 304 the maintenance data (e.g., maintenance data 224, 226, 228, 230) to generate the consolidated maintenance information (e.g., consolidated maintenance information 146) concerning the one or more fracking pumps (e.g., fracking pumps 208, 210, 212, 214) based, at least in part, upon the maintenance data (e.g., maintenance data 224, 226, 228, 230). For example, maintenance monitoring process 100 may process 304 the maintenance data (e.g., maintenance data 224, 226, 228, 230) and combine and correlate the discrete pieces of information contained therein (e.g., crew data; failure data; inventory data; efficiency data; and identifying data) to generate the consolidated maintenance information (e.g., consolidated maintenance information 146) concerning the one or more fracking pumps (e.g., fracking pumps 208, 210, 212, 214).

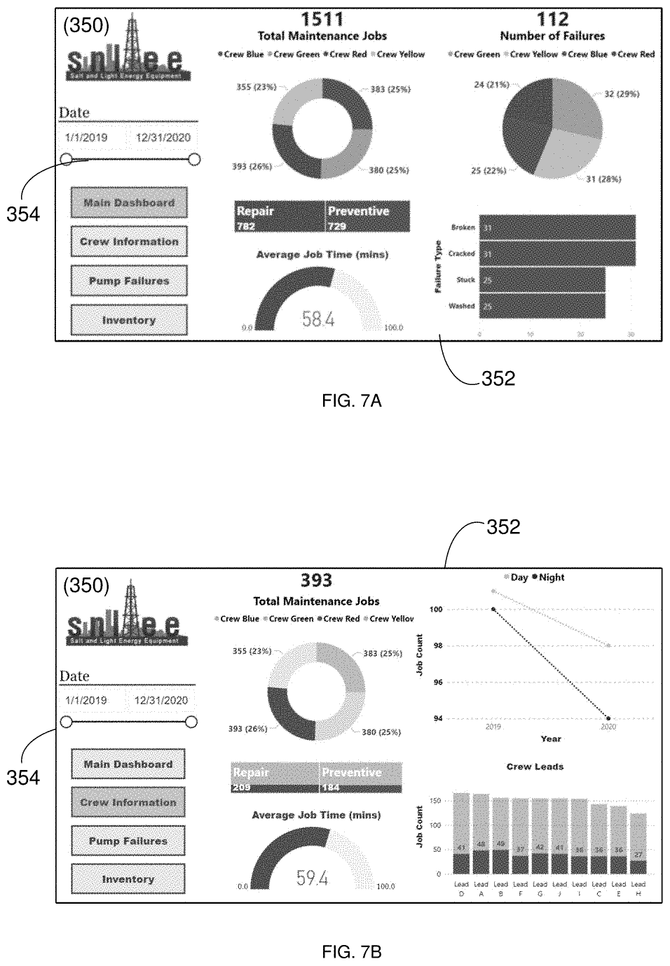

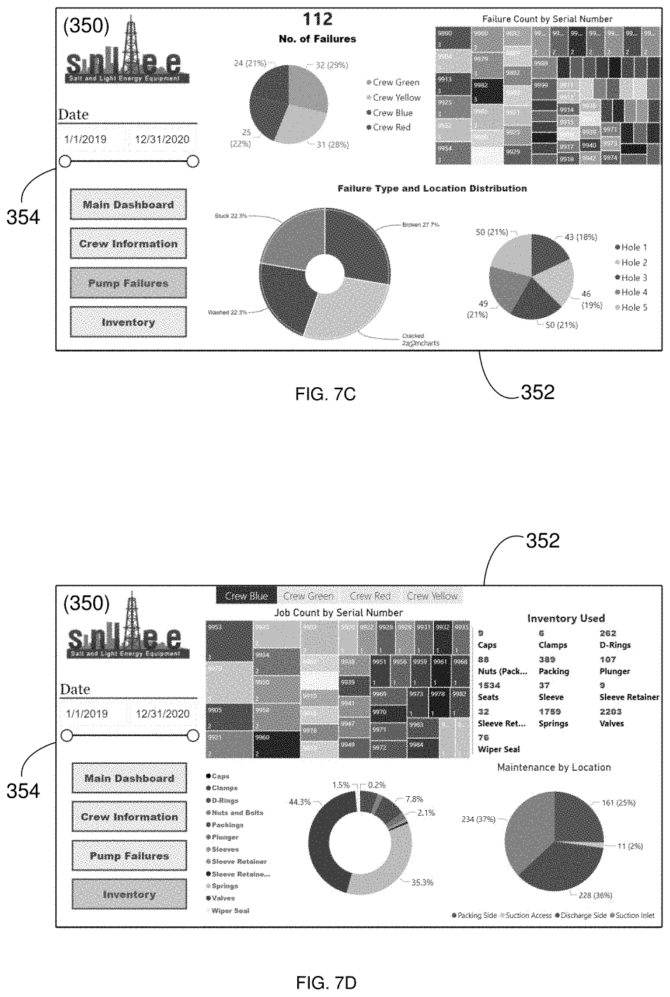

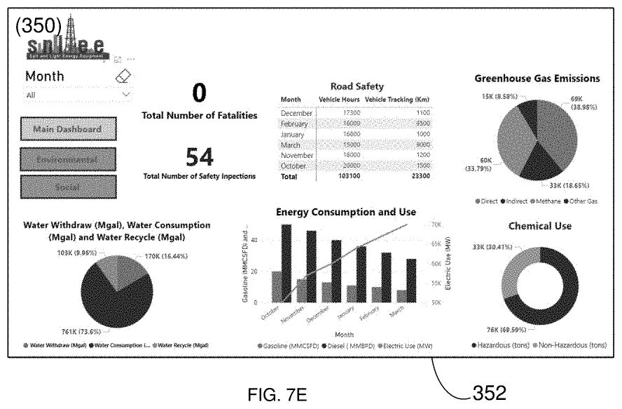

Referring also to FIGS. 7A, 7B, 7C, 7D & 7E, maintenance monitoring process 100 may render 306 a graphical user interface (e.g., graphical user interface 350) that is configured to present at least a portion of the consolidated maintenance information (e.g., consolidated maintenance information 146) to a user (e.g., one or more of users 126, 128, 130, 132 and/or one or more members of one or more of maintenance crews 216, 218, 220, 222), thus defining rendered consolidated maintenance information (e.g., rendered consolidated maintenance information 352) within e.g., graphical user interface 350.

The graphical user interface (e.g., graphical user interface 350) may be configured to allow the user (e.g., one or more of users 126, 128, 130, 132 and/or one or more members of one or more of maintenance crews 216, 218, 220, 222) to define an observation window (e.g., observation window 354). For example, observation window 354 may be configured to allow the user (e.g., one or more of users 126, 128, 130, 132 and/or one or more members of one or more of maintenance crews 216, 218, 220, 222) to define a time-based window for reviewing the consolidated maintenance information (e.g., consolidated maintenance information 146). In this particular example, the time-based window is 1 Jan. 2019 through 31 Jan. 2020.

The rendered consolidated maintenance information (e.g., rendered consolidated maintenance information 352) defined within the graphical user interface (e.g., graphical user interface 350) may include one or more of: consolidated general information (as shown in FIG. 7A); consolidated crew information (as shown in FIG. 7B); consolidated failure information (as shown in FIG. 7 C); consolidated inventory information (as shown in FIG. 7D); and environmental information (as shown in FIG. 7E).

For example and as shown in FIG. 7A, rendered consolidated maintenance information 352 may define various pieces of general information, examples of which may include but are not limited to:
total job count (@ 1511 jobs)
job distribution per crew (@ 355 jobs for the yellow crew, 393 jobs for the red crew, 383 jobs for the blue crew & 380 jobs for the green crew)
job distribution (@ 782 “repair” jobs & 729 “preventive” jobs).
average job time (@ 58.4 minutes)
total failure count (@ 112 failures)
failure distribution per crew (@ 31 failures for the yellow crew, 24 failures for the red crew, 25 failures for the blue crew & 32 failures for the green crew)
failure distribution per type (@ 31 “broken” failures, 31 “cracked” failures, 25 “stuck” failures & 25 “washed” failures)

For example and as shown in FIG. 7B, rendered consolidated maintenance information 352 may define various pieces of crew information for a specific crew (e.g., the red crew), examples of which may include but are not limited to:
crew-specific job count for the red crew (@ 393 jobs)
crew-specific job distribution for the red crew (@ 209 “repair” jobs & 184 “preventive” jobs).
average job time for the red crew (@ 59.4 minutes)
day/night job distribution for the red crew
crew leads for the red crew (for all leads versus red crew leads)

For example and as shown in FIG. 7C, rendered consolidated maintenance information 352 may define various pieces of failure information, examples of which may include but are not limited to:
total failure count (@ 112 failures)
failure distribution per crew (@ 31 failures for the yellow crew, 24 failures for the red crew, 25 failures for the blue crew & 32 failures for the green crew)
failure distribution per type (@ 27.7% “broken” failures, 27.7% “cracked” failures, 22.3% “stuck” failures & 22.3% “washed” failures)
failure distribution per hole/cylinder (@ 43 for Hole 1, 46 for Hole 2, 50 for Hole 3, 49 for Hole 4 & 50 for Hole 5)
failure distribution per serial number

For example and as shown in FIG. 7D, rendered consolidated maintenance information 352 may define various pieces of inventory information, examples of which may include but are not limited to:
job count per serial number
inventory distribution by percentage
inventory distribution by item type
maintenance by location (packing side/suction access/discharge side/suction inlet)

For example and as shown in FIG. 7E, rendered consolidated maintenance information 352 may define various pieces of environmental information, examples of which may include but are not limited to:
fatality count
safety inspection count
water statistics (withdrawn/consumed/recycled)
road safety
energy consumption/used
greenhouse gas emissions
chemical usage

Maintenance monitoring process 100 may process 308 the consolidated maintenance information (e.g., consolidated maintenance information 146) to generate one or more recommendations (e.g., recommendations 150) concerning the one or more fracking pumps (e.g., fracking pumps 208, 210, 212, 214). In order to accomplish this task, maintenance monitoring process 10 may utilize machine learning.

As is known in the art, a machine learning system or model may generally include an algorithm or combination of algorithms that has been trained to recognize certain types of patterns. For example, machine learning approaches may be generally divided into three categories, depending on the nature of the signal available: supervised learning, unsupervised learning, and reinforcement learning.

As is known in the art, supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). As is known in the art, reinforcement learning may generally include a computing device interacting in a dynamic environment in which it must perform a certain goal (such as driving a vehicle or playing a game against an opponent).

As it navigates its problem space, the program is provided feedback that's analogous to rewards, which it tries to maximize. While three examples of machine learning approaches have been provided, it will be appreciated that other machine learning approaches are possible within the scope of the present disclosure.

The one or more recommendations (e.g., recommendations 150) generated by maintenance monitoring process 100 may include one or more: maintenance recommendations concerning the one or more fracking pumps (e.g., fracking pumps 208, 210, 212, 214); inspection recommendations concerning the one or more fracking pumps (e.g., fracking pumps 208, 210, 212, 214); and replacement recommendations concerning the one or more fracking pumps (e.g., fracking pumps 208, 210, 212, 214).

Maintenance Recommendations: As discussed above, maintenance monitoring process 100 may process 304 the maintenance data (e.g., maintenance data 224, 226, 228, 230) to generate the consolidated maintenance information (e.g., consolidated maintenance information 146) concerning the one or more fracking pumps (e.g., fracking pumps 208, 210, 212, 214). Accordingly and using such a machine learning process, maintenance monitoring process 100 may process 308 consolidated maintenance information 146 to identify and extract maintenance patterns. For example, if maintenance monitoring process 100 processes 308 consolidated maintenance information 146 and identifies a maintenance pattern of replacing the lubricating oil within a fracking pump after every 200 hours of use, the one or more recommendations (e.g., recommendations 148) may recommend that the lubricating oil within a fracking pump be replaced every 200 hours.

Inspection Recommendations: As discussed above, maintenance monitoring process 100 may process 304 the maintenance data (e.g., maintenance data 224, 226, 228, 230) to generate the consolidated maintenance information (e.g., consolidated maintenance information 146) concerning the one or more fracking pumps (e.g., fracking pumps 208, 210, 212, 214). Accordingly and using such a machine learning process, maintenance monitoring process 100 may process 308 consolidated maintenance information 146 to identify and extract inspection patterns. For example, if maintenance monitoring process 100 processes 308 consolidated maintenance information 146 and identifies an inspection pattern of inspecting packing assembly 52 after every 100 hours of use, the one or more recommendations (e.g., recommendations 148) may recommend that packing assembly 52 within a fracking pump be inspected every 100 hours.

Replacement Recommendations: As discussed above, maintenance monitoring process 100 may process 304 the maintenance data (e.g., maintenance data 224, 226, 228, 230) to generate the consolidated maintenance information (e.g., consolidated maintenance information 146) concerning the one or more fracking pumps (e.g., fracking pumps 208, 210, 212, 214). Accordingly and using such a machine learning process, maintenance monitoring process 100 may process 308 consolidated maintenance information 146 to identify and extract replacement patterns. For example, if maintenance monitoring process 100 processes 308 consolidated maintenance information 146 and identifies a replacement pattern of replacing packing assembly 52 after every 200 hours of use, the one or more recommendations (e.g., recommendations 148) may recommend that packing assembly 52 within a fracking pump be replaced every 200 hours. This may be especially true if maintenance monitoring process 100 processes 308 consolidated maintenance information 146 and identifies a failure pattern wherein packing assembly 52 is very likely to fail after 250 hours of use.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
monitoring one or more maintenance operations performed on one or more fracking pumps to generate consolidated maintenance information concerning the one or more fracking pumps; and
rendering a graphical user interface that is configured to present at least a portion of the consolidated maintenance information to a user, thus defining rendered consolidated maintenance information.

2. The computer-implemented method of claim 1 wherein the rendered consolidated maintenance information includes one or more of:
consolidated general information;
consolidated crew information;
consolidated failure information; and
consolidated inventory information.

3. The computer-implemented method of claim 1 wherein monitoring one or more maintenance operations performed on one or more fracking pumps to generate consolidated maintenance information concerning the one or more fracking pumps includes:
receiving maintenance data concerning one or more maintenance operations performed on one or more fracking pumps.

4. The computer-implemented method of claim 3 wherein monitoring one or more maintenance operations performed on one or more fracking pumps to generate consolidated maintenance information concerning the one or more fracking pumps further includes:
processing the maintenance data to generate the consolidated maintenance information concerning the one or more fracking pumps based, at least in part, upon the maintenance data.

5. The computer-implemented method of claim 3 wherein the maintenance data includes one or more of:
crew data;
failure data;
inventory data;
efficiency data; and
identifying data.

6. The computer-implemented method of claim 1 further comprising:
processing the consolidated maintenance information to generate one or more recommendations concerning the one or more fracking pumps.

7. The computer-implemented method of claim 6 wherein the one or more recommendations include one or more maintenance recommendations.

8. The computer-implemented method of claim 6 wherein the one or more recommendations include one or more inspection recommendations.

9. The computer-implemented method of claim 1 wherein the one or more recommendations include one or more replacement recommendations.

10. The computer-implemented method of claim 1 wherein the graphical user interface is configured to allow the user to define an observation window.

11. A computer program product residing on a computer readable medium having a plurality of instructions stored thereon which, when executed by a processor, cause the processor to perform operations comprising:
monitoring one or more maintenance operations performed on one or more fracking pumps to generate consolidated maintenance information concerning the one or more fracking pumps; and
rendering a graphical user interface that is configured to present at least a portion of the consolidated maintenance information to a user, thus defining rendered consolidated maintenance information.

12. The computer program product of claim 11 wherein the rendered consolidated maintenance information includes one or more of:
consolidated general information;
consolidated crew information;
consolidated failure information; and
consolidated inventory information.

13. The computer program product of claim 11 wherein monitoring one or more maintenance operations performed on one or more fracking pumps to generate consolidated maintenance information concerning the one or more fracking pumps includes:
receiving maintenance data concerning one or more maintenance operations performed on one or more fracking pumps.

14. The computer program product of claim 13 wherein monitoring one or more maintenance operations performed on one or more fracking pumps to generate consolidated maintenance information concerning the one or more fracking pumps further includes:
processing the maintenance data to generate the consolidated maintenance information concerning the one or more fracking pumps based, at least in part, upon the maintenance data.

15. The computer program product of claim 13 wherein the maintenance data includes one or more of:
crew data;
failure data;
inventory data;
efficiency data; and
identifying data.

16. The computer program product of claim 11 further comprising:
processing the consolidated maintenance information to generate one or more recommendations concerning the one or more fracking pumps.

17. The computer program product of claim 16 wherein the one or more recommendations include one or more maintenance recommendations.

18. The computer program product of claim 16 wherein the one or more recommendations include one or more inspection recommendations.

19. The computer program product of claim 11 wherein the one or more recommendations include one or more replacement recommendations.

20. The computer program product of claim 11 wherein the graphical user interface is configured to allow the user to define an observation window.

21. A computing system including a processor and memory configured to perform operations comprising:
monitoring one or more maintenance operations performed on one or more fracking pumps to generate consolidated maintenance information concerning the one or more fracking pumps; and
rendering a graphical user interface that is configured to present at least a portion of the consolidated maintenance information to a user, thus defining rendered consolidated maintenance information.

22. The computing system of claim 21 wherein the rendered consolidated maintenance information includes one or more of:
consolidated general information;
consolidated crew information;
consolidated failure information; and
consolidated inventory information.

23. The computing system of claim 21 wherein monitoring one or more maintenance operations performed on one or more fracking pumps to generate consolidated maintenance information concerning the one or more fracking pumps includes:
receiving maintenance data concerning one or more maintenance operations performed on one or more fracking pumps.

24. The computing system of claim 23 wherein monitoring one or more maintenance operations performed on one or more fracking pumps to generate consolidated maintenance information concerning the one or more fracking pumps further includes:
processing the maintenance data to generate the consolidated maintenance information concerning the one or more fracking pumps based, at least in part, upon the maintenance data.

25. The computing system of claim 23 wherein the maintenance data includes one or more of:
crew data;
failure data;
inventory data;
efficiency data; and
identifying data.

26. The computing system of claim 21 further comprising:
processing the consolidated maintenance information to generate one or more recommendations concerning the one or more fracking pumps.

27. The computing system of claim 26 wherein the one or more recommendations include one or more maintenance recommendations.

28. The computing system of claim 26 wherein the one or more recommendations include one or more inspection recommendations.

29. The computing system of claim 21 wherein the one or more recommendations include one or more replacement recommendations.

30. The computing system of claim 21 wherein the graphical user interface is configured to allow the user to define an observation window.
